(19) United States
(12) Patent Application Publication
(10) Pub. No.: US 2003/0083904 A1
(43) Pub. Date: May 1, 2003

(54) Method and system for the transitional care of congestive heart failure patients

(76) Inventors: John Voytas, Waterford, MI (US); Debra Kowalski, Troy, MI (US)

Correspondence Address: HARNESS, DICKEY & PIERCE, P.L.C., P.O. BOX 828, BLOOMFIELD HILLS, MI, 48303, US

(21) Appl. No.: 10/238,999

(22) Filed: Sep. 10, 2002

Related U.S. Application Data
(60) Provisional application No. 60/318,640, filed on Sep. 13, 2001.

(51) Int. Cl. G06F 17/60

(52) U.S. Cl. 705/2

(57) ABSTRACT

A method for the transitional care of patients, including but not limited to congestive heart failure patients, includes the step of conducting a hospital consultation prior to a discharge from an extended hospital stay. When a patient is identified as being a proper candidate for a transitional care facility, the patient is discharged to the transitional care facility. At the transitional care facility, the patient is repeatedly educated regarding topics selected from the group of warning signs, medication, diet and exercise. The patient is tested for a level knowledge regarding the one or more topics. A transitional care facility consultation is conducted to determine whether the patient is a proper candidate for discharge to home care. In such event, the patient is discharged to home care and a summary is generated to a referring physician of the patient regarding a recommendation for continued care.

### CROSS-REFERENCE TO RELATED APPLICATION

This application is based on provisional patent application which has been assigned U.S. Serial No. 60/318,640, filed Sep. 10, 2001.

### FIELD OF THE INVENTION

The present invention generally relates to patient care. More particularly, the present invention relates to a method and system for the transitional care of patients discharged from a hospital. In one particular application, the present invention relates to a method and system for the transitional care of congestive heart failure patients which should significantly reduce the incidence of early hospital readmittance.

### BACKGROUND OF THE INVENTION

Before a patient is discharged from an extended hospital stay, discharge instructions are conventionally provided that detail such items as continuing medication, exercise and diet. These instructions are not always sufficiently followed by the discharged patient. This is particularly true for geriatric patients whom often require more time to comprehend detailed instructions and in addition often become deconditioned while bedfast in the hospital.

More recently, transitional facilities have been made available to care for discharged patients between the hospital and home. Such transitional facilities can be effective in reducing the length of many hospital visits. Using congestive heart failure as an example, many patients are readmitted to the hospital with reoccurring symptoms within a short period despite the use of conventional discharge planning.

As pertinent background for the exemplary application of the teachings of the present invention, congestive heart failure is a syndrome that occurs when the heart is unable to produce enough output of blood to meet the energy demands of body tissues and organs. The most common causes of heart failure include chronic high blood pressure, coronary artery disease, and dysfunction of heart valves and/or muscle.

Despite much progress in the treatment of vascular diseases, congestive heart failure remains a debilitating syndrome affecting approximately four million Americans at an annual cost of over $40 billion dollars. Heart failure is the number one reason for admission and readmission to hospitals for Medicare benefit recipients. Approximately eighty percent (80%) of heart failure admissions are persons over 65 years of age.

Currently, nearly twenty percent (20%) of patients with heart failure return to the hospital within one month of discharge and nearly one half of the patients are readmitted within six months. Furthermore, the prevalence of heart failure is projected to double over the next 30 years as the population of the United States and the rest of the world continues to live longer. However, the cycle of frequent hospital admissions, increasing loss of function, and reduced quality of life to those with heart failure may not be inevitable.

Traditional hospital care focuses on current symptoms. It is imperative in the elderly that the comorbidities often associated with heart failure which impede progress (such as profound deconditioning, polypharmacy, gait disturbance, depression, malnutrition, orthostatic hypotension, and incontinence) be effectively managed. It remains a need in the pertinent art to provide a system of care for patients such as heart failure patients in a structured interdisciplinary environment. Patients will benefit from rehabilitation in a transitional heart improvement center that “closes the loop” between hospital and home.

### SUMMARY OF THE INVENTION

In one form, the present invention relates to a method for the transitional care of patients. The method includes the following general steps:

conducting a hospital consultation prior to a discharge from an extended hospital stay;

identifying a patient as proper for a transitional care facility;

discharging the patient to the transitional care facility;

repeatedly educating the patient at the transitional care facility regarding one or more topics selected from the group of warning signs, medication, diet and exercise;

testing the patient for a level of knowledge regarding the one or more topics;

conducting a transitional care facility consultation;

identifying the patient as proper for home care;

discharging the patient to home care; and

generating a letter to a the referring physician of the patient regarding a recommendation for continued care and a summary of transitional carestay.

A potential advantage of the present invention is the provision of a method and system of patient care which reduces the length of hospital stays and occurrences of readmittance.

Another potential advantage of the present invention is the provision of a method and system of patient care which thoroughly educates a patient on topics such as disease warning signs, medication, exercise and diet through transitional care effectively improving “customer satisfaction”.

A related potential advantage of the present invention is the provision of a method and system of patient care which automatically generates a summary to the referring physician of a transitional care patient upon discharge.

Another potential advantage of the present invention is the provision of a method and system of patient care which provides a more efficient setting for management of the comorbidities that often accompany heart failure.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawing, wherein:

FIG. 1 is a flow diagram illustrating the general steps of a preferred method according to the teachings of the present invention.

### DETAILED DESCRIPTION OF THE PREFERRED EMBODIMENT

The description of the invention is merely exemplary in nature and, thus, variations that do not depart from the gist of the invention are intended to be within the scope of the invention. Such variations are not to be regarded as a departure from the spirit and scope of the invention.

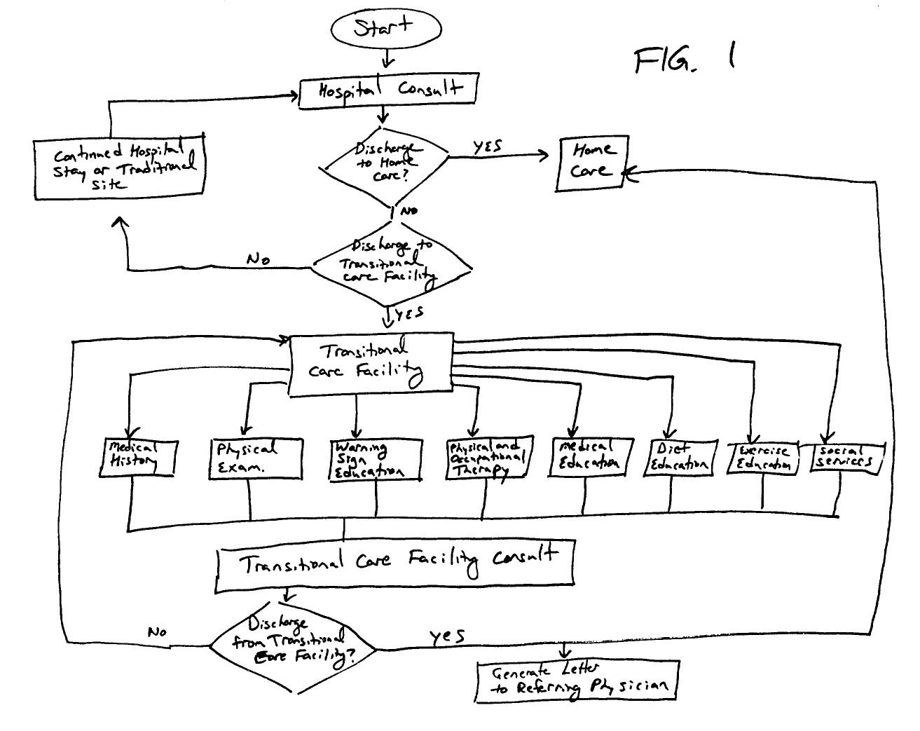

With reference to the flow diagram of FIG. 1, the general steps of a preferred method for the transitional care of patients are set forth. In the exemplary application that will be described herein, the method is used for the transitional care of congestive heart failure patients. However, it will become apparent to those skilled in the art that the teachings of the present invention have applicability for various other disease syndromes.

In an initial step, a hospital consultation is conducted to determine the continued care required for the patient. In limited circumstances, the patient will be discharged directly to home care. Such circumstances may be more common for hospital stays necessitated by conditions other than heart failure.

Where the patient requires continued care, the hospital consultation determines whether the patient is a proper candidate for discharge to a transitional care facility. If the patient is not such a proper candidate, the hospital stay is continued. Where the patient is such a proper candidate, discharge is made to the transitional care facility.

The hospital consultation is typically conducted by the division of Geriatric Medicine. One suitable form that can be used for the evaluation of transitional care appropriateness is attached at Appendix A. The form at Appendix A lists various criteria used to assess the patient. Preferably, the forms are available on a computer and the input data can be entered into the computer. Alternatively, manual entries can be made to the form.

Upon arrival at the transitional care facility, the patient's medical history is recorded and a physical examination is conducted. One suitable form for documenting the history and physical is attached at Appendix B. Preferably, the relevant information including the name of the patient's referring physician is computer inputted. Again, the data may be manually entered on the form.

New patients to the transitional care facility are provided with an instructional booklet and an interactive, educational CD-ROM, an exemplary booklet is attached at Appendix C. The booklet provides a recordal area for important names and numbers and sets forth warning signs that should trigger the patient to call his or her doctor. The booklet additionally includes charts to track weight gain and medication schedules. The forms provided in the booklet may be made available on a computer for data entry.

Images of the computer screens generated by the interactive, educational CDROM are attached at Appendix D. The CD-ROM educates the patients on topics including a description of heart failure, heart failure symptoms, the causes of heart failure, medications, exercise and rest. The CD-ROM includes a true or false quiz that the patient may take to assess a level of knowledge regarding the topics of the CDROM.

The daily responsibilities of a rehabilitation specialist and the responsibilities of Social Services for an exemplary application of the teachings of the method of the present invention are set forth in Appendix E.

Attached at Appendix F is a daily nursing shift progress report. As with the various forms discussed above, the progress report may be available on a computer for data entry. In this manner, the information can be saved on the computer and the data can be accessed for tracking patient progress and generating reports documenting such progress. Safeguards can be built into the computer/software to identify inappropriate values. Statistical analysis will be conducted at intervals for normative evaluation and finally for summative evaluation. Analyzed results will be interpreted and translated into reports to be disimminated to concern community organizations (e.g., hospitals and nursing homes).

Returning particularly to the flowchart of FIG. 1, a transitional care facility consultation is conducted to determine whether the patient should be discharged therefrom. The transitional care facility consult takes into consideration the patient's medical history, physical exam results and the level of knowledge obtained by the patient regarding the various continued care topics. The results of the physical exam ensure that the symptoms of heart failure have been adequately controlled and that all reversible causes of morbidity have been treated or stabilized. The CD-ROM education provides both patients and caregivers with important information concerning medications, diet, activity exercise recommendations and symptoms of worsing heart failure.

In the event that it is determined that the patient is not prepared for discharge, the patient remains at the transitional care facility until appropriate for discharge.

When it is determined that the patient is prepared for discharge from the transitional facility, the patient is discharged with recommendation for continued home care. Adequate outpatient support and follow-up care are arranged. A letter is generated to the patient's referring physician regarding transitional care stay and recommendations for continued care. Such a letter would advise the physician on weight recordal and medication documenting that can be expected by the patient. In one application of the teachings of the method of the present invention, the discharge status of the patient to home care is inputted into a computer and the computer automatically generates the letter to the cardiologist in response to such inputting of the discharge status.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the description of the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for the transitional care of patients, the method comprising the steps of:
conducting a hospital consultation prior to a discharge from an extended hospital stay;
identifying a patient as a proper candidate for a transitional care facility;
discharging the patient to the transitional care facility;
repeatedly educating the patient at the transitional care facility regarding one or more topics selected from the group of warning signs, medication, diet and exercise;
testing the patient for a level of knowledge regarding the one or more topics;
conducting a transitional care facility consultation;
identifying the patient as a proper candidate for home care;
discharging the patient to home care; and
generating a summary to a referring physician of the patient regarding a transitional care stay and a recommendation for continued care.

2. The method for the transitional care of patients of claim 1, further including the step of documenting a medical history for the patient.

3. The method for the transitional care of patients of claim 2, wherein the step of documenting a medical history for the patient includes the step of inputting the medical history into a computer.

4. The method for the transitional care of patients of claim 3, further comprising the step of inputting a discharge status of the patient to home care in the computer.

5. The method for the transitional care of patients of claim 4, wherein the step of generating a letter to a cardiologist includes the step of automatically generating the letter in response to the step of inputting the discharge status of the patient.

6. The method for the transitional care of patients of claim 1, wherein the patient is a congestive heart failure patient.
